(19) United States
(12) Patent Application Publication
(10) Pub. No.: US 2014/0195963 A1
(43) Pub. Date: Jul. 10, 2014

(54) METHOD AND APPARATUS FOR REPRESENTING 3D THUMBNAILS

(71) Applicant: GEHRY TECHNOLOGIES, (US)

(72) Inventors: Jim Chi-Kwan CHEUNG, Santa Monica, CA (US); Dennis SHELDEN, Los Angeles, CA (US)

(73) Assignee: GEHRY TECHNOLOGIES, Los Angeles, CA (US)

(21) Appl. No.: 13/717,620

(22) Filed: Dec. 17, 2012

Related U.S. Application Data
(63) Continuation-in-part of application No. 13/717,371, filed on Dec. 17, 2012.
(60) Provisional application No. 61/576,892, filed on Dec. 16, 2011.
(60) Provisional application No. 61/576,921, filed on Dec. 16, 2011.
(60) Provisional application No. 61/576,921, filed on Dec. 16, 2011.

(51) Int. Cl. G06F 3/0482

(52) U.S. Cl. CPC G06F 3/0482
USPC 715/781; 715/838

(57) ABSTRACT

A method and related system are disclosed for generating a rotatable thumbnail representation of a 3D model of an object stored in a CAD file. Method steps include translating content of the CAD file into a neutral graphics format, converting the translated file content into a succession of views of the object, each successive view presenting a different perspective of the object as it rotates about a common axis, converting the successive views to a sequence of thumbnail-sized images, associating the sequence with a single thumbnail representation of the CAD file, and configuring the thumbnail representation to enable a user to preview the CAD file on a graphical user interface by displaying the thumbnail-sized images according to the sequence to simulate rotation of the object about the common axis. The resulting 3D thumbnail is universally viewable, for example, in a browser, without opening application software used to create the 3D model.

### RELATED APPLICATIONS

The present application claims priority to U.S. Provisional Application No. 61/576,921 (filed Dec. 16, 2011) and to U.S. Provisional Application No. 61/576,892 (filed Dec. 16, 2011), both of which are fully incorporated herein by reference.

The present application is related to U.S. patent application Ser. No. 13/717,371 entitled “Method and Apparatus for Detecting Interference in Design Environment” (Attorney Docket No. GTI-0100) filed on an even date herewith and fully incorporated herein by reference.

### BACKGROUND OF THE INVENTION

1. Field of the Invention

The present invention relates to computer graphics, more particularly, to computerized methods for representing three-dimensional views of objects, and most specifically to a universal viewer that generates a rotatable three-dimensional thumbnail representing a graphical object regardless of file type.

2. Description of the Related Art

There are a large number of computer-aided design (CAD) tools available today. In some cases, a user may use more than one of the tools to generate or other view three-dimensional (3D) models. At times, a user may wish to search for a 3D model of interest in a file directory but may not remember the name of the model. Or, the user may wish to look at a collection of 3D models so that the visual representation may be used to more easily discern the model of interest.

A disadvantage of current technology is that each CAD product uses a proprietary format for rendering its images. Therefore it is often not possible to view images created by a tool unless the user has installed an authorized copy of the tool on his computer. Even if the user has installed multiple different CAD tools, it is not possible with today's technology to view the graphical contents of a collection of CAD files at the same time if the files are written in different, incompatible formats. Instead, the user is limited to viewing only those contents that are associated with a particular CAD tool that is selected for viewing the files, which generally slows the searching process.

In some cases, the user would prefer to preview thumbnail sized images when browsing through a file directory. However, when the files in a file directory are associated with multiple different CAD formats, at best only a limited number of files can have their contents rendered as a thumbnail due to the incompatible formats. What is needed is a more universal tool capable of rendering a thumbnail image for any CAD format that reveals the graphical contents to a user.

### SUMMARY OF THE INVENTION

The present invention provides a universal viewer that allows thumbnails of 3D models generated by different CAD tools to be visualized without opening application software for a CAD tool. The 3D models may be rotated within the thumbnail image, allowing for useful viewing of a 3D model for enhanced identification. In one embodiment, the invention provides a file management application that provides a file directory of rotatable 3D thumbnails for presentation on a graphical user interface (GUI), such as in conjunction with a Windows or Mac operating system. In another embodiment, a system according to the invention is configured so that when a user positions a cursor to hover over a 3D thumbnail, an expanded view of the 3D model represented by the thumbnail appears in a preview window, which allows the user to simulate rotation of the model about an axis to display a variety of perspectives. In another embodiment, the system is configured to expand the view of the 3D model from the thumbnail view or from the preview window into a full view that allows rotation of the model about two or three axes. The system may also provide a plurality of thumbnail sizes from which to choose.

A method according to the invention for generating a rotatable thumbnail representation of a 3D model of an object stored in a CAD file is disclosed herein as a series of process steps. The steps may be embodied as a series of processor-executable steps stored in a computer readable medium. Salient steps of the method include: translating content of the CAD file into a neutral graphics format, then converting the translated file content into a succession of views of the object, each successive view presenting a different perspective of the object as it rotates about a common axis. Then, converting the successive views to a sequence of thumbnail-sized images, associating the sequence with a single thumbnail representation of the CAD file, and configuring the thumbnail representation to enable a user to preview the CAD file on a graphical user interface by displaying the thumbnail-sized images according to the sequence to simulate rotation of the object about the common axis. In one embodiment, each of the successive views may be displaced from adjacent views by a common angle, such as 30 degrees, so that a user may rotate the object through a sequence of twelve perspectives. In another embodiment, the single thumbnail representation may be selected from one of the successive views.

In more elaborate embodiments, the object displayed in the preview window or in a full view window may be rotated about more than one axis. Another feature of the invention allows a user to simulate rotation of the object dragging a cursor within the preview window, or by selecting a rotation arrow that is displayed within the preview window.

A system according to the invention is also disclosed for generating a rotatable thumbnail representation of a 3D model of an object stored in a CAD file. The system includes at least one processor, a computer readable medium that is operatively coupled to the processor, and logic that executes at least in part in the processor from the computer readable medium and that, when executed, causes generation of the rotatable thumbnail representation by executing the salient steps of the method described above. The system may comprise a single computing device, or may comprise a network of devices cooperating in a client-server relationship.

In a network embodiment of the invention, any number of client computing devices may be served via a network, such as the Internet cloud, to achieve the methods described above and the results thereof. For example, a user operating a computing device may execute a method according to the invention by uploading a CAD file of a 3D model via the cloud to a translation server, which is configured to receive 3D models from a variety of platforms and in a variety of formats authored by a number of CAD tools. The uploaded file may then be converted into a neutral graphics format that is universally readable, for example, by a browser. In the same translation server or at a second server, multiple thumbnails images are generated from the converted file, each showing a different perspective view of the 3D model as it is rotated about a common axis. These images are packaged together into a viewable 3D thumbnail, which may be browser readable so that universal viewing of the thumbnails is possible. The 3D thumbnail may optionally be uploaded to a cloud storage server 103. From there, the 3D thumbnail may be uploaded to a content delivery server for streaming to the user upon demand for more efficient service.

Whether the system operates locally or through client interaction with one or more servers, the user receives in response to executing the method, a universally readable 3D thumbnail that represents the contents of the uploaded CAD file and that includes all of the features of a rotatable 3D thumbnail disclosed herein.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals designate like parts throughout the different views, wherein:

FIG. 1 is a block diagram illustrating one embodiment of a system according to the invention, which provides a network environment for practicing methods according to the invention.

FIG. 2 is a block diagram illustrating salient process steps in a method according to the invention for presenting 3D thumbnails.

FIG. 3 is a process flow chart illustrating salient steps in one embodiment of a method according to the invention for presenting 3D thumbnails.

FIG. 4 is a process flow chart illustrating salient steps in another embodiment of a method according to the invention for presenting 3D thumbnails.

FIG. 5 is a diagram of one embodiment of a graphical user interface portion of a system of the invention for display on a computer screen that presents 3D thumbnails according to methods of the present invention.

FIG. 6 is a diagram of a preview window generated as a graphical user interface for presenting 3D thumbnails according to methods and systems of the present invention.

FIG. 7 is a graphical representation of a succession of 3D thumbnail views that each represent the same object of interest encoded in a CAD file and that collectively show all possible perspectives of the 3D thumbnail as a user rotates the thumbnail through 360 degrees while browsing a file list, according to one embodiment of the invention.

FIG. 8 shows a sampling of different 3D images of a translated CAD file after expanding a 3D thumbnail to full view and rotating it about various axes according to an embodiment of the invention.

FIG. 9 is a block diagram illustrating functional modules of a translation and imaging server according to an embodiment of a system of the present invention.

### DETAILED DESCRIPTION

Generally speaking, the present invention provides a method for viewing 3D models from a plurality of CAD tools and allows for the rotation of the models in thumbnail form. According to the invention, a 3D rendering tool cooperates with file management software to generate 3D views of CAD models for user inspection without opening the corresponding CAD application software. The 3D rendering tool operates such that any computing device equipped with an Internet browser is capable of inspecting 3D CAD files, either in thumbnail form or in an expanded view. Using the 3D rendering tool, a user of the computing device is able to quickly view the graphical contents of CAD files, regardless of the CAD file format in which the file being viewed is written. This offers the user the advantage of ensuring that a file of interest is positively identified before opening the file to perform additional work.

The term “thumbnail” as used herein means a miniature image or a reduced-size representation of a larger image. A thumbnail also serves as an index or a link to a digital file or to a URL. For example, a thumbnail may serve as an icon in a GUI-based operating system, which when selected, causes execution of a software application such as a graphics program that enables the larger or full-sized version on the thumbnail image to be displayed. A thumbnail image may contain less data than the full version of the image from which the thumbnail is derived. When rendered, the thumbnail is typically rectangular with dimensions anywhere from about 75 to 250 pixels in any dimension. Some typical pixel sizes for thumbnails are 75×75, 150×150, 160×160 and 250×250, and may be rectangular rather than square.

The term “neutral graphics format” or “vendor-neutral graphics format” means code for digital images that can be recognized and rendered by dissimilar CAD/CAM or imaging systems without the need for translation. An early example of a neutral graphics format was any format that followed the Initial Graphics Exchange Specifications (IGES). Neutral graphics format also means a binary file format that is portable across multiple platforms, such as the Platform Neutral Format (PNG).

The term “common axis” as used herein means any one of the three axes (x,y,z) in a Cartesian coordinate system.

The term “perspective” as used herein, in the context of a viewing angle for a simulated 3D image, has the same meaning as that given in the field of drafting. For example, a perspective view is an approximate representation of a 3D image on a 2D surface achieved using a viewing angle that is displaced from aligning precisely along any of the Cartesian axes (x,y,z). Objects drawn in a perspective view may become smaller as their distance from the observer increases, and the size of an object's dimensions along the line of sight may be relatively shorter than dimensions across the line of sight. For purposes of this disclosure, the definition of perspective view encompasses an isometric view.

The terms “hovering”, “selecting”, and “dragging” as used herein denote manual actions performed by a computer user manipulating the controls on an input device known as a mouse. Hovering means positioning the cursor that is associated with the position of the mouse without clicking one of the selection buttons of the mouse. Selecting means clicking one of the mouse buttons (i.e. pressing and releasing) to execute a software routine that is associated with an image on a GUI when the cursor is co-located with the image being selected. Dragging means the user manipulates the mouse by pressing and holding one of the mouse buttons while moving the mouse, causing the cursor to move while the mouse button is held pressed.

The term “preview” as used herein means the ability to view the contents of an image file without executing the software application (e.g. a CAD program) which was used to create the image.

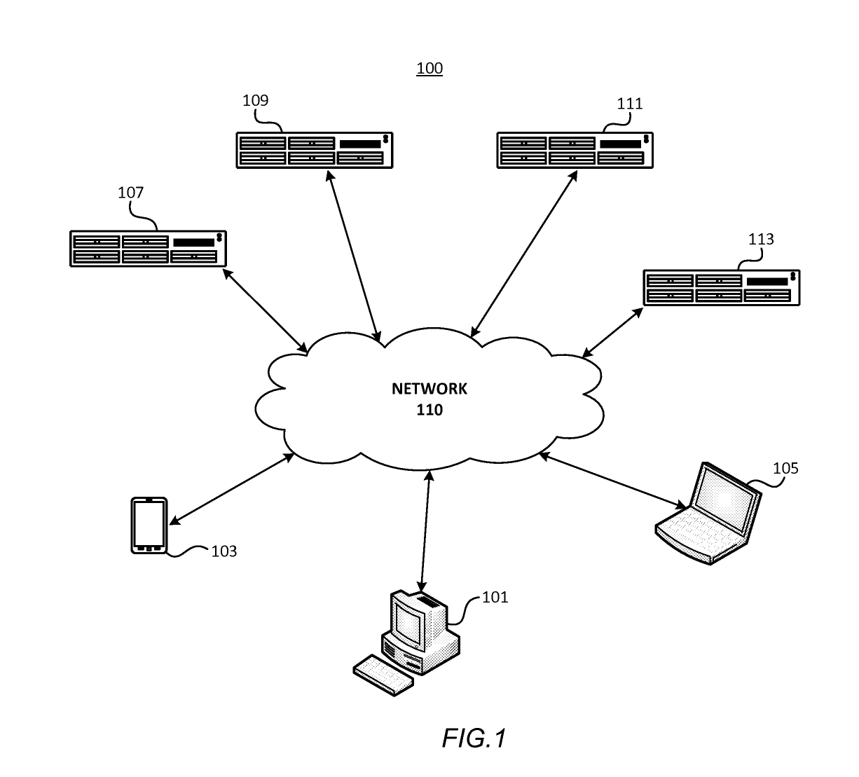

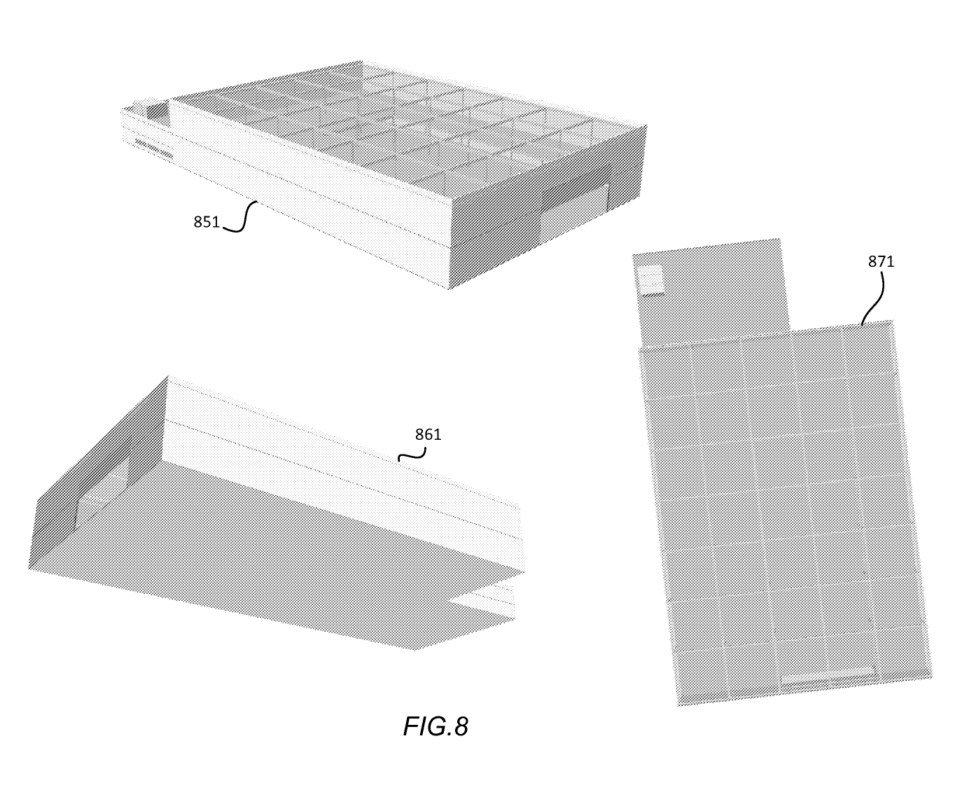

FIG. 1 is a block diagram of one embodiment of a system 100 according to the invention. System 100 provides a network environment for practicing an embodiment of a method according to the invention. The system includes multiple client computing devices and multiple servers, each connected to the network 110, which is the Internet in this illustrative embodiment. The computing devices may include a desktop computer 101, a mobile computing device 103 (e.g. cell phone or tablet), and a laptop computer 105. The servers may include a translation server 107, an imaging server 109, a cloud storage server 111, and a content delivery server 113. Generally, each of the computing devices and servers includes functional modules similar to those depicted in FIG. 8. The operation of individual computing devices and servers and techniques for effecting network communications among them are well known and not further discussed herein.

In one embodiment, a system according to the invention may be configured in hardware, software, or firmware, or in any combination of these, within any one of the computing devices 101, 103, and 105, and any device so configured may execute a method of the invention as described herein. In another example, a computing device 101, 103, or 105 may communicate with one or more of the servers to execute methods of the invention. For example, the system may consist of desktop computer 101 and server 107, such that CAD images uploaded from computer 101 to the server 107 are processed by the server 107 and downloaded after processing to computer 101 as rotatable 3D thumbnails according to the invention. Other combinations of devices and servers that comprise a system of the invention are possible within the scope of the invention, and examples of such combinations are discussed as follows.

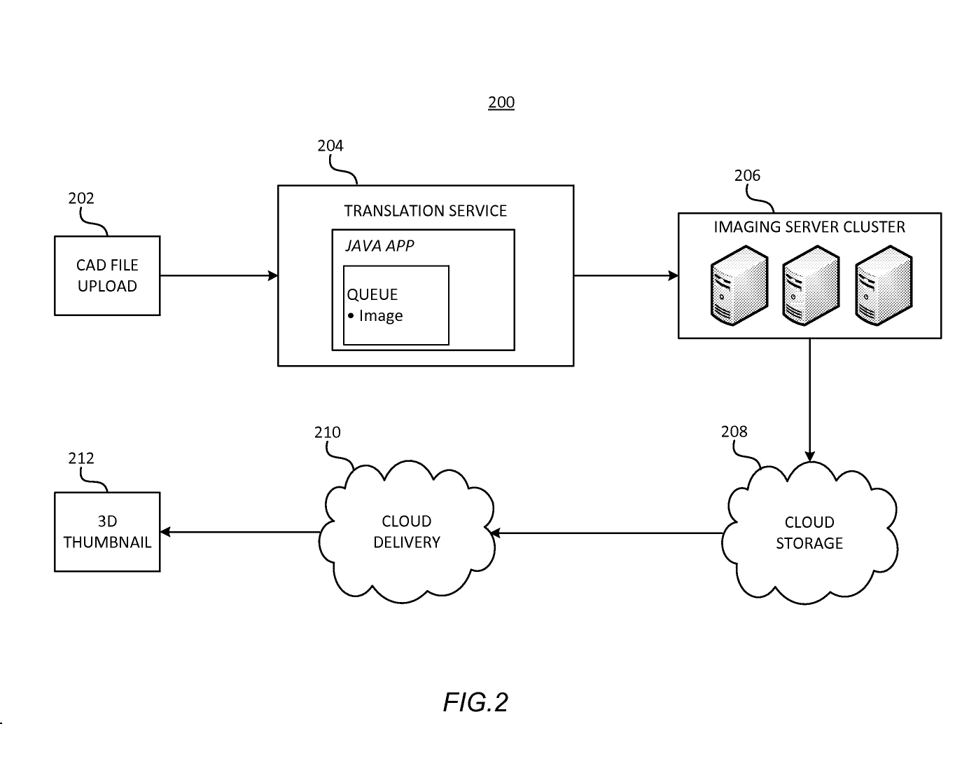

FIG. 2 is a functional block diagram of a system 200 according to one embodiment of the invention. The system 200 operates in a network environment, such as the network 100. FIG. 2 may also be interpreted as a method according to the invention, as each component in the diagram performs a process step.

The first component is block 202, which represents a user's computing device uploading a CAD or other graphics file to a translation server 204 via a network connection. In this illustrative example, although only one user computing device sends only one CAD file in only one upload, these singularities are understood to represent, potentially, the actions of multiple computing devices uploading multiple graphics files written in many different CAD formats. The CAD or other graphics file being uploaded at block 202 contains information for rendering a simulated 3D image of an object of interest, such as an architectural drawing created in a CAD format.

Regardless of the format of a CAD file received by translation server 204, the translation server is configured with graphics format translation logic to recognize and read any CAD or graphics format that has been commercialized or publicized, within reasonable practical limitations. For example, in one embodiment of the invention, the translation server 204 utilizes as its graphics format translation logic, a GTX platform, such as that used with the Genetica product available from Spiral Graphics, Inc. This enables the translation server 204 to receive and process 3D models from a variety of platforms and in a variety of formats authored by a number of CAD tools.

The translation server 204 reads the uploaded CAD file and translates the model into a neutral graphics format. In one embodiment, server 204 uses for this purpose an open source file format known as GTO developed by Tweak Films. The translation server 204 may be implemented via a JAVA application.

In one embodiment, the translation server 204 transmits the translated 3D model file to an imaging server 206 for further processing. In another embodiment, the translation server 204 and the imaging server 206 can be implemented in a single translation and imaging server. In another embodiment, the translation server 204 uses the GTX platform to convert a 3D model directly into thumbnail format. For example, the converted files can be made browser readable prior to producing a succession of thumbnail views for the 3D thumbnail.

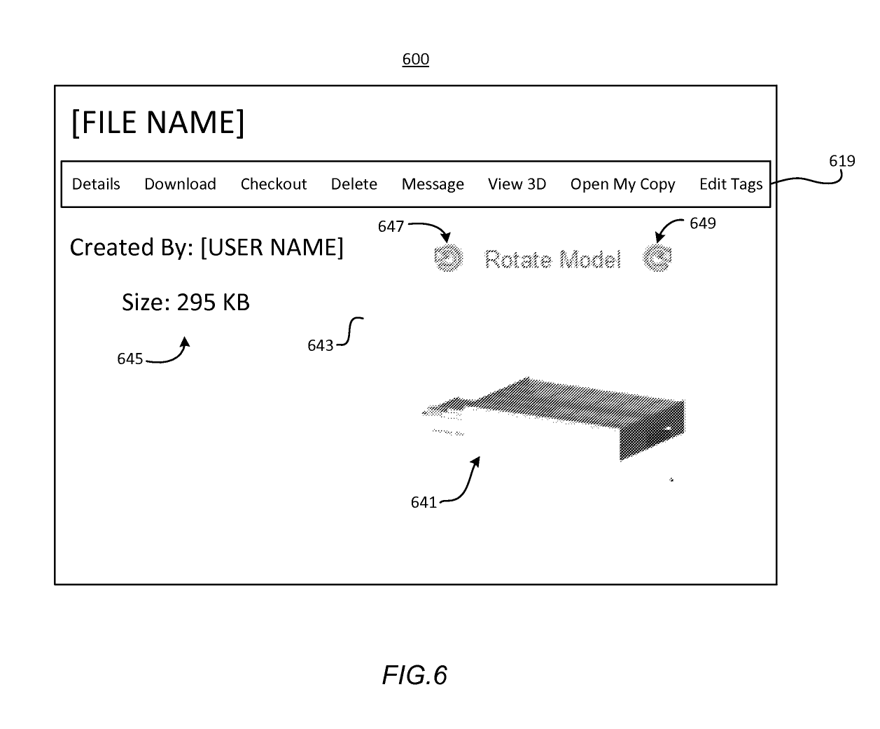

Imaging server 206 assists in the conversion of the CAD file into a 3D thumbnail. Imaging server 206 receives the translated 3D model from translation server 204 and executes thumbnail image generation logic to generate a succession of views of the 3D model of the object represented by the original upload. To accomplish this, the thumbnail image generation logic of imaging server 206 is programmed to capture a series of “snapshot” views of the 3D image, one snapshot for each increment of rotation of the 3D object about an axis of rotation. In an exemplary embodiment, as depicted in FIG. 6, there may by 12 such incremental steps, and in this case each snapshot in the series depicts the 3D image from the perspective of a successive 30-degree rotation of the 3D thumbnail image about a common axis, e.g., the vertical axis in a Cartesian coordinate system.

As each snapshot is captured, the thumbnail image generation logic converts each view to a thumbnail-sized image and stores each such image in a 3D thumbnail file that comprises the output of imaging server 206, i.e. the 3D thumbnail comprises multiple perspective views of the object arranged in a definite sequence. The series of views advantageously reduces the amount of data that needs to be stored to render the 3D thumbnail, but provides enough information to enable the human viewer of the 3D thumbnail to ascertain the identity of the 3D model that the 3D thumbnail represents.

Imaging server 206 may also create or append additional rendering code to the 3D thumbnail that contains instructions for displaying the perspective views in the proper sequence for simulating rotation of the object of interest about a common axis. The rendering code may also include instructions for associating the sequence of perspective views with a single thumbnail representation of the object of interest, and for displaying the single thumbnail representation as an icon that links to the original CAD or other graphics file from which the 3D thumbnail was derived. The single thumbnail representation may be one of the series of perspective views, or it may be another, different view that is generated independently from the series. The rendering code may also include instructions for associating the icon with a file directory window on a GUI, similar to the Windows Explorer directory in a Windows operating system. In one embodiment, the file directory window is browser-readable. The rendering code may also include instructions for enabling the series of perspective views to be displayed in proper sequence in a preview window separate from the file directory window.

The rendering code may also include instructions for generating a full size view of the model in a neutral graphics format, which may be rotatable in a viewing window about one or more orthogonal axes. In another embodiment, the imaging server 206 may be configured to generate different sizes of thumbnail views to allow a user to select from among the different thumbnail sizes when customizing the product.

After conversion, the 3D thumbnail file containing the plurality of perspective views may be uploaded to cloud storage server 208. In one embodiment the cloud storage server 208 comprises an Amazon simple storage service (S3) cloud.

When a request is pending for a 3D thumbnail of an CAD file uploaded at 202, the 3D thumbnail from cloud storage server 208 may be forwarded to cloud delivery server 210. In one embodiment, the cloud delivery server 210 may comprise a CloudFront content delivery network (CDN) such as provided by Amazon Web Services. It is understood that any suitable network storage and delivery services may be used, whether cloud based or otherwise.

The exemplary system 200 employs a dual cloud approach for file storage and delivery, which in one embodiment provides certain advantages. For example, an S3 cloud allows for a substantially instantaneous file update, while an AWS CloudFront may delay updates to files, but allows for superior streaming of digital content.

At the final component block 212, a 3D thumbnail is received from cloud delivery server 210 at the user's computing device from which the CAD file was loaded at block 202. The received 3D thumbnail comprises the plurality of perspective thumbnail-sized views of the object of interest, each translated into a neutral graphics format. In addition, the 3D thumbnail may include or be accompanied by the rendering code that contains instructions for displaying the perspective views in the proper sequence for simulating rotation of the object of interest about a common axis. The 3D thumbnail may also include or be accompanied by the rendering code that contains instructions for displaying a full size view of the model in a neutral graphics format, which view may be rotated about one or more orthogonal axes to simulate rotation in free space. The 3D thumbnail may also include the rendering code for displaying the single thumbnail representation as an icon that links to the original CAD or other graphics file from which the 3D thumbnail was derived.

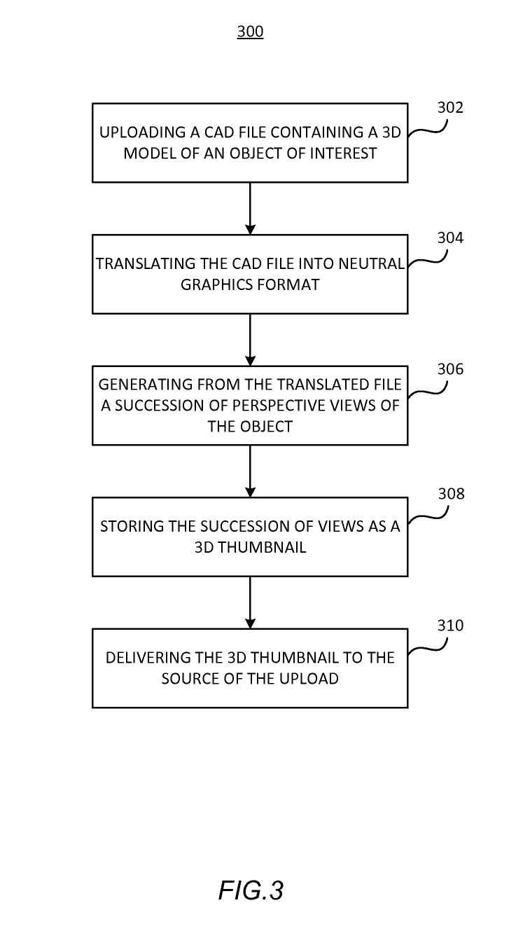

FIG. 3 is a process flow chart illustrating one embodiment of a method 300 according to the invention for presenting 3D thumbnails. Method 300 summarizes salient steps of the process described above in the description of system 200. The method begins at step 302, during which a 3D model such as a CAD file is imported into the system, for example, using an import function for a local implementation of the method, or via upload for a network implementation. The file includes contents that represent a 3D model of an object of interest. At the next step 304, using graphics format translation logic, the CAD file is translated into a neutral graphics format. At the next step 306, thumbnail image generation logic is executed to generate, from the translated file, a succession of perspective views of the object. Preferably, each view in the succession of views represents the object as seen at different phases of rotation about a common axis. At the next step 308, the succession of views is collected into a single 3D thumbnail, which may also include various additional rendering instructions as discussed above. This step may be summarized as a step for storing the succession of views as a 3D thumbnail, for example, in cloud storage or at some other memory location. At the final step 310, the 3D thumbnail is delivered to the source of the upload, or to another location specified by the original file exporter. In this step, for example, the 3D thumbnail may be delivered to a browser for viewing at the source of the upload. Internet Explorer, Mozilla Firefox, and Google Chrome are examples of browsers at the present state of the art that are capable of viewing 3D thumbnails according to the invention without needed to execute CAD application software.

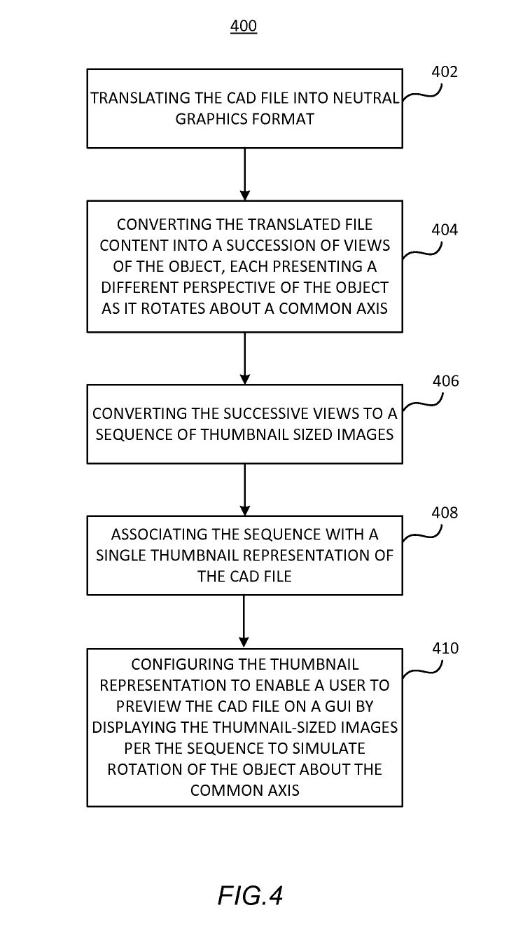

FIG. 4 is a process flow chart illustrating salient steps in another embodiment of a method 400 according to the invention for presenting 3D thumbnails. More specifically, method 400 may be considered as a process for generating a rotatable thumbnail representation of a 3D model of an object stored in a CAD file. The method may be carried out in a network environment, or entirely within a single computing device.

Method 400 begins at step 402, during which the content of a CAD file is translated into a neutral graphics format. Next, at step 404, the translated file is converted into a succession of views of the object. Each of the views presents a different perspective of the object as it rotates about a common axis. The succession of views may be, for example, a sequence of views at successive phases of rotation about a vertical or a horizontal axis, or about a slanted axis such as one that forms a 45 degree angle with respect to the vertical and horizontal axes. The sequence of views occurs in an order whereby each successive view is displaced from an adjacent view by a common angle of rotation, for example, 30 degrees.

Next, at step 406, each of the successive views is converted to a sequence of thumbnail-sized images. This conversion step may be carried out using thumbnail image generation logic. At the next step 408, the sequence of thumbnail images is associated with a single thumbnail representation of the CAD file. The single thumbnail representation may comprise a graphical representation of the object, and may or may not be selected from among the sequence of thumbnail images. Associating the sequence with the single thumbnail representation of the CAD file allows the single thumbnail representation to serve as a viewable icon or pointer to the 3D thumbnail to enable rendering thereof. In the final step 410, the thumbnail representation is configured to enable the user to preview the object contained in the CAD file on a GUI by displaying the thumbnail-sized images according to the sequence to simulate rotation of the object about a common axis.

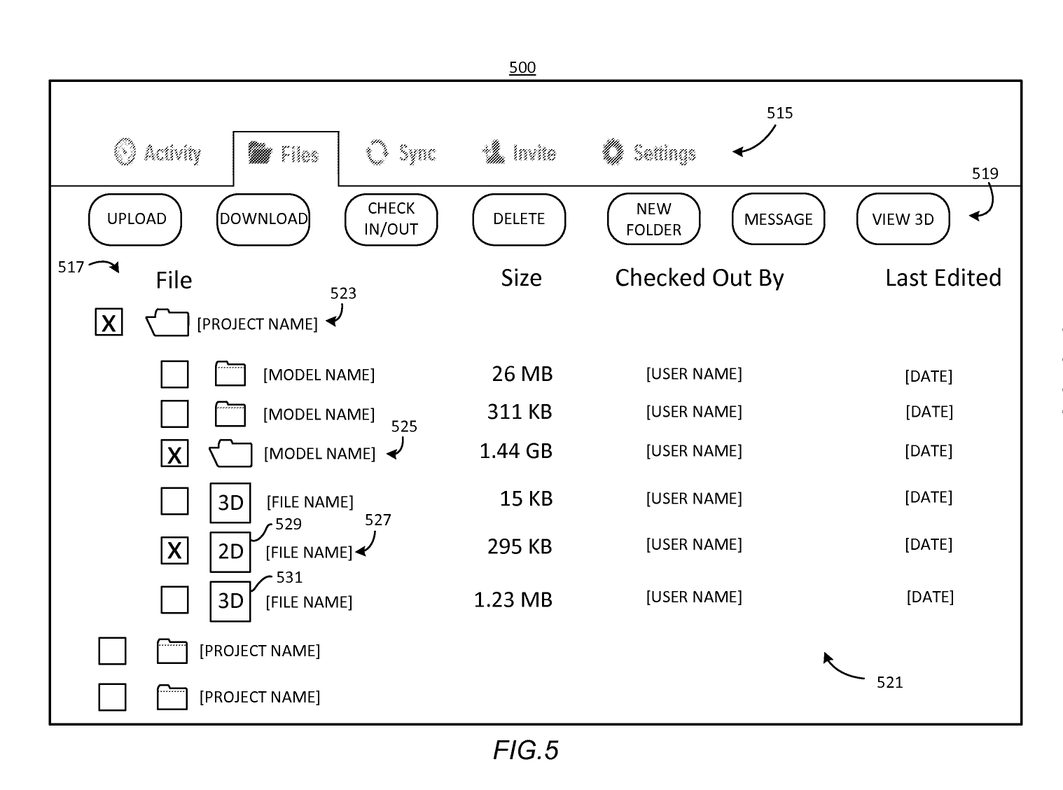

FIG. 5 is a diagram of one embodiment of a GUI portion of a system of the invention for display on a computer screen that presents 3D thumbnails according to methods of the present invention. The diagram represents a user-interface window 500 as it would appear on the monitor of a computing device, e.g. device 105, that is executing software embodying one or more methods of the present invention.

Window 500 comprises a display of a file directory in which 3D thumbnails may be advantageously accessed by a user. Many features of window 500 are optional and common to similar user interface controls known in the art. For example, a menu bar 515 may be provided near the top of the window to allow the user to access various features and functions organized under main headings related to file management. These headings are titled Activity, Files, Sync, Invite, and Settings. In this illustrative example, the Files heading is shown in the open or selected state to reveal a directory of digital files 517. The directory 517 shows a list of filenames for CAD and other graphics files and provides an environment for exploitation of 3D thumbnails. Other features ancillary to the invention are also shown for exemplary purposes, and these include a task bar 519 that allows a user to execute certain operations on files or folders listed in the directory 517, and a data table shown to the right of the list of filenames in the area denoted generally as 521. The data table displays a list of information related to each file in directory 517, which may include the size of the file (Size), the name of a user who is currently working on the file (Checked Out By), the date that the file was most recently updated (Last Edited), and may also include many other items of interest about the file (not shown).

In particular, task bar 519 includes an executable Upload button that enables a user to upload a CAD file from the file directory for conversion and delivery of a 3D thumbnail according to the invention. The 3D thumbnail returned to the user can then be associated with the CAD file and stored as an icon representing the CAD file in the same file directory.

To illustrate, a user may select a file for representation as a 3D thumbnail by navigating to the file through the file folder hierarchy, which in this example consists of selecting a particular project name 523 from among Project folders to reveal a list of Models, selecting a particular model name 525 from among the Model folders, and finally selecting a particular 3D graphics file 527 from among the filenames beneath the selected Model folder. Selection of a folder or file is indicated by an X or other mark appearing in the selection box adjacent to the folder or file. Selection of a filename may also be indicated by highlighting the filename 527 or its adjacent icon 529. In this example, a normal, two-dimensional (2D) thumbnail (icon 529) exists for filename 527. The user executes a conversion of filename 527 to a 3D thumbnail by selecting the filename and, while it is indicated as selected, moving the cursor to the Upload button and selecting the Upload button. This action sets in motion a method of the invention such as those described above for generating and delivering a 3D thumbnail. When the 3D thumbnail is received, the system of the invention replaces the 2D icon 529 with a 3D thumbnail, such as 3D thumbnail 531. With a 3D thumbnail in place within the file directory, the rotatable thumbnail features of the invention may be executed by the user, as further described below.

FIG. 6 is a diagram of a preview window 600 generated as a GUI for presenting 3D thumbnails according to methods and systems of the present invention. A system or method according to the invention causes preview window 600 to appear on a display screen of a computer monitor when a user desires to visualize a 3D thumbnail and rotate the 3D thumbnail, for example, to gain a better understanding of an object of interest encoded within a CAD file. In one embodiment, the preview window 600 may be invoked by the user by manipulating controls that appear in the user-interface window 500.

In a first example, a user seeking to preview CAD file contents may position the cursor to hover over the 3D thumbnail 531. The act of hovering causes execution of rendering code associated with the 3D thumbnail, which in this case results in the preview window 600 being displayed on a portion of the user's computer monitor. In one embodiment, preview window 600 appears next to its corresponding 3D thumbnail, generally within the area 521 of window 500. In a second example, the user may select a 3D thumbnail, such as thumbnail 531, and while the thumbnail is selected, then select the View 3D button from the task bar 519. This action has an identical effect, resulting in display of the preview window 600. Invocation of code that causes changes in the GUI display may be accomplished using methods known in the art.

When the preview window 600 appears, an enlarged version 641 of the thumbnail image 531 may appear in the preview window within an inner window 643, as shown. An optional menu bar 619 may also be displayed within the preview window. The enlarged image 641 may be a different view of the object of interest than that of the single thumbnail representation of image 531. Additional data 645 pertaining to the selected file may also be displayed in the preview window. The user may now execute various operations associated with the 3D thumbnail. These operations include the ability to simulate a rotation of the image 641 within the inner window 643.

In one example, the user may rotate the image 641 by clicking and dragging the cursor within the inner window 643. As the cursor is dragged within the inner window from side to side, or from top to bottom, or generally along a curved or circular path, the image 641 changes commensurately with movement of the dragging cursor to simulate rotation of the image. Rotation is simulated by switching the image displayed in the inner window sequentially among the succession of thumbnail views that are associated with the 3D thumbnail. In another example, the user may simulate rotation of the image 641 by selecting one of the rotation arrows 647 (for counterclockwise rotation) or 649 (for clockwise rotation). Each selection of a rotation arrow 647 or 649 switches the current view to an adjacent view in the sequence consistent with the simulated direction of rotation.

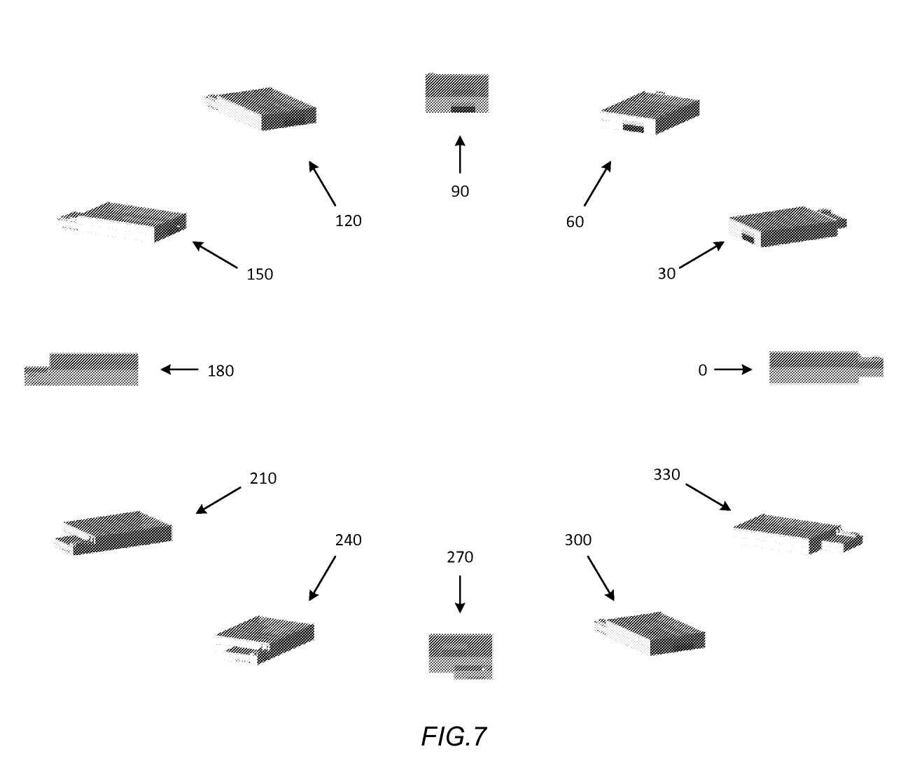

FIG. 7 is a graphical representation of a succession of 3D thumbnail views that each represent an object of interest encoded in a CAD file and that collectively show all possible perspectives of the 3D thumbnail as a user rotates the thumbnail through 360 degrees while browsing a file list, according to one embodiment of the invention. For ease of reference, each view in FIG. 7 is labeled with a number that corresponds to the number of degrees to which the object was rotated when a snapshot was taken to capture the view. These labels are 0, 30, 60, 90, 120, 150, 180, 210, 240, 270, 300, and 330 degrees. Other embodiments of the invention are possible wherein more or fewer angles are selected to comprise the succession of views. The intervals in degrees between adjacent views may be the same (as in FIG. 7), or in other embodiments the intervals may be irregular.

The object shown in each of the successive views in FIG. 7 is the same object seen in the exemplary expanded view 641 of 3D thumbnail 531. The 3D thumbnail 531 will, in a preferred embodiment, appear as one of the successive views, although in another embodiment the 3D thumbnail may comprise a view different than all of the successive views. In another embodiment, the system may allow the user to specify which of the successive views will appear as the 3D thumbnail 531. In the expanded view 641, which appears in the preview window 643, the appearance of the object will change according to the degree of rotation selected by the user, but the appearance is limited to being one of the successive views at any instant of time. In practice, as a user causes the image in the preview window to rotate, the image switches rapidly from one adjacent perspective view to the next, as if the user were holding a 3D object in hand and rotating it about in space.

As illustrated in FIGS. 6 and 7, the expanded view 641 in preview window 643 corresponds to perspective view 150, which shows the object of interest rotated 150 degrees about a vertical axis with respect to the 0 degree image. Given the 150 degree starting point, if a user selects the clockwise arrow 649, rendering code causes the view of the object within the preview window to switch to perspective view 120, which is the adjacent to perspective view 150 in the clockwise direction. Similarly, if the user selects the counterclockwise arrow 647, the view within the preview window will switch to perspective view 180, which is adjacent to perspective view 150 in the counterclockwise direction. For a 3D thumbnail configured for simulated rotation about a common axis, each of the perspective views that collectively compose the 3D thumbnail is adjacent to exactly two other perspective views.

In the similar operation that simulates rotation, whereby the user drags a cursor within the preview window, the view within the preview window switches among the perspective views in a clockwise or counterclockwise sequence from one adjacent view to the next. This allows the user to quickly ascertain the form and appearance of the 3D model encoded within the CAD file without leaving the file directory window and without having to open the CAD file.

Those skilled in the art will appreciate that the fundamental concepts disclosed herein for simulating rotation of a 3D thumbnail-sized model about a single axis can be extended to the case where rotation is possible about two or three orthogonal axes, to simulate additional degrees of freedom in free space. This concept is illustrated in FIG. 8, which shows a sampling of different 3D images of a translated CAD file after expanding a 3D thumbnail to full view and rotating it about various axes according to an embodiment of the invention.

In one embodiment of the invention, the images in FIG. 8 can be achieved by expanding a selected 3D thumbnail to a full view in a size greater than the enlarged view shown in the preview window 643. The full size view may be displayed using menu options provided with the 3D thumbnail. For example, from window 500, the user may select a filename, and while the filename is selected, the user may further select the View 3D option on the task menu 519. Alternatively, while the preview menu 600 is displayed, the user may directly select the View 3D option on menu bar 619. Selection of the View 3D option causes the full size view of the object of interest to be displayed.

The user may execute one of the aforementioned View 3D menu options to achieve the full view in a new window that allows the object to be rotated about any of three orthogonal axes. By way of illustration, item 851 shows a full perspective view of the object of interest rotated about 120 degrees about a vertical axis. Item 861 shows the same object rotated again about both the vertical axis and a left-to-right horizontal axis. Item 871 shows the same object rotated again about the vertical axis, and about both orthogonal horizontal axes.

Each of the full views 851, 861 and 871 represents a different state of rotation of the object as displayed in the new window. In one embodiment, each of the full views is rendered from a neutralized file that resulted from graphics format translation logic converting the uploaded or exported CAD file into a neutral format according to the invention. In another embodiment, the converted file may be packaged with the succession of perspective views that compose the 3D thumbnail prior to delivery of the 3D thumbnail to the requester. In another embodiment, the converted file may allow any desired angle of rotation about any axis to be rendered in a browser window or file directory window without being accompanied by pre-packaged succession of perspective vies. In any case, the converted file typically shows much less detail than the original CAD drawing, but uses far less memory and this allows the neutralized image to be quickly rendered on a GUI such as a browser window. Sufficient detail is retained to allow the user to ascertain the contents of the antecedent CAD file.

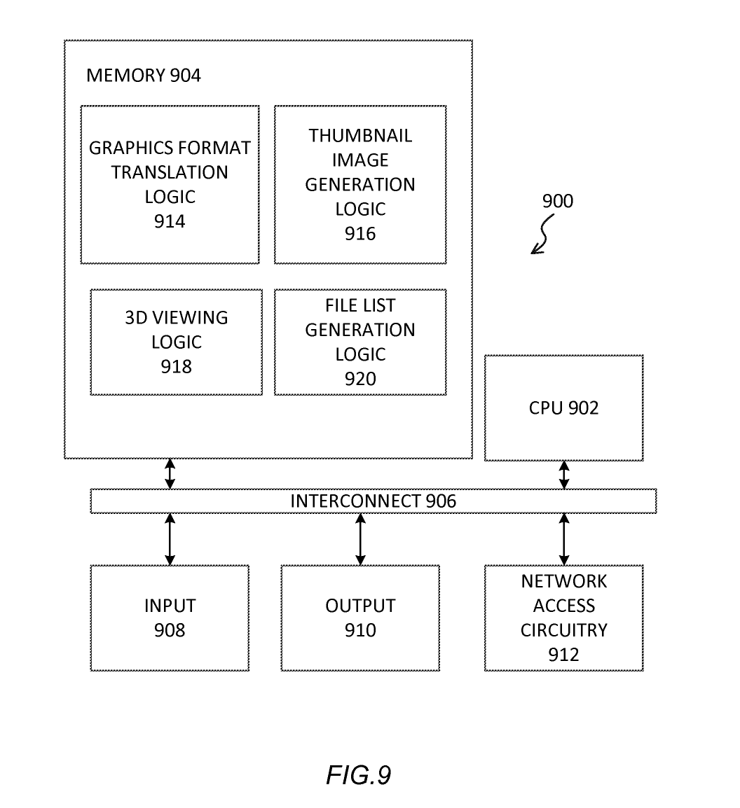

FIG. 9 is a block diagram illustrating functional modules of a translation and imaging server 900 according to an embodiment of a system of the present invention. The translation and imaging server is configured to execute steps of the methods described above and particularly the functions attributed to servers 204 and 206.

The server 900 can include, for example, one or more microprocessors, which are collectively shown as CPU 902. The server 900 also includes, for example, a memory 904, an interconnect 906, an input 908, an output 910, and a network access circuitry 912. The CPU 902 can retrieve data or instructions from the memory 904 and execute the retrieved instructions. The memory 904 can include generally any computer-readable medium including, for example, persistent memory such as magnetic and/or optical disks, ROM, and PROM and volatile memory such as RAM.

The CPU 902 and the memory 904 are connected to one another through the interconnect 906, which is a bus in this illustrative embodiment. The interconnect 906 connects the CPU 902 and the memory 904 to input devices 908, output devices 910, and network access circuitry 912. The input devices 908 are optional, and may include, for example, a keyboard, a keypad, a touch-sensitive screen, a mouse, a microphone, and one or more cameras. The output devices 910 are also optional and may include, for example, a display—such as a liquid crystal display (LCD)—and one or more loudspeakers. The network access circuitry 912 sends and receives data through computer networks such the network 110 (FIG. 1).

A number of components of the server 900 are stored in the memory 904. In particular, graphics format conversion logic 914 is part of one or more computer processes executed within the CPU 902 from the memory 904 in this illustrative embodiment, but can also be implemented using digital logic circuitry. Likewise the thumbnail image generation logic 916, the 3D viewing logic 918, and the file list generation logic execute within the CPU 902 from the memory 904, and may also be implemented in digital logic circuitry.

In one embodiment, the graphics format conversion logic 914 is executable software stored within the memory 904. For example, when the graphics format conversion logic 914 is executed, it can convert computer code for rendering a graphical image according to process step 304 or 404 as described herein.

In one embodiment, the thumbnail image conversion logic 916 is executable software stored within the memory 904. For example, when the thumbnail image conversion logic 916 is executed, it can generate, from a converted or neutralized CAD file, one or more thumbnail-sized images that compose the perspective views that are used to simulate rotation of the 3D thumbnail, according to process step 306 or 406 as described herein.

Modules 918 and 920 for, respectively, 3D viewing logic 918 and file list generation logic 920 may also comprise executable software stored within memory 904. When executed, these modules cause the various GUI windows of the invention to be displayed to enable presentation of the perspective views, preview windows, control menus, and other features shown and described herein. The basic structure of the server 900 is also representative of other computing devices and servers described herein, although the contents of memory 904 will change with each device depending on the software stored therein.

In view of the description herein of the fundamental principles of the invention, it can be appreciated that in one embodiment the 3D thumbnail may be characterized as software encoded in neutral graphics format and configured to render images of a model in three distinct stages, which include (i) a static icon representation, (ii) an enlarged 3D representation rotatable about at least one axis in a preview window, and (iii) a full size 3D representation rotatable about at least one axis in another window. Preferably, the full size 3D representation is rotatable about multiple orthogonal axes. Preferably, the model is viewable in all three stages using a state-of-the-art browser. Preferably, 3D thumbnails according to the invention are configured so that when represented as static icons, multiple such representations may be rendered simultaneously on a GUI, for example, in a file directory window.

As described herein, the terms “component”, “module”, “system”, “server” and the like each refer to a computer-related entity, either hardware, firmware, a combination of hardware and software, software, or software in execution. For example, a module can be, but is not limited to being, a process running on a processor, a processor, an object, an executable, a thread of execution, a program, or a computer. By way of illustration, both an application running on a computing device and the computing device itself may comprise a module. One or more modules can reside within a process or thread of execution and a module can be localized on one computer or distributed between two or more computers. In addition, these modules can execute from various computer readable media having various data structures stored thereon. The computer readable media may be transitory or non-transitory. The modules can communicate by way of local or remote processes such as in accordance with a signal having one or more data packets (e.g. data from one component interacting with another component in a local system, distributed system, or across a network with other systems by way of the signal.

Those skilled in the art will appreciate that the various illustrative logical blocks, modules, circuits, methods, and algorithms described in connection with the examples disclosed herein may be implemented as electronic hardware, computer software, or combinations of both. To clearly illustrate this interchangeability of hardware and software, various illustrative components, blocks, modules, circuits, methods, and algorithms have been described above generally in terms of their functionality. Whether such functionality is implemented as hardware or software depends upon the particular application and design constraints imposed on the overall system. Implementations in software may be effected using conventional programming languages using code that achieves the requirements of the foregoing specification.

Exemplary embodiments of the invention have been disclosed in an illustrative style, and accordingly, the terminology employed throughout should be read in an exemplary rather than a limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method for generating a rotatable thumbnail representation of a three-dimensional (3D) model of an object stored in a computer-aided design (CAD) file, comprising:
translating content of the CAD file into a neutral graphics format;
converting the translated file content into a succession of views of the object, each successive view presenting a different perspective of the object as it rotates about a common axis;
converting the successive views to a sequence of thumbnail-sized images;
associating the sequence with a single thumbnail representation of the CAD file; and
configuring the thumbnail representation to enable a user to preview the CAD file on a graphical user interface by displaying the thumbnail-sized images according to the sequence to simulate rotation of the object about the common axis.

2. The method of claim 1 wherein the common axis is a vertical axis.

3. The method of claim 1 wherein each of the successive views is displaced from adjacent views by a common angle.

4. The method of claim 3 wherein the angle is 30 degrees.

5. The method of claim 1 wherein the single thumbnail representation comprises one of the successive views.

6. The method of claim 1 wherein the thumbnail representation is configured to enable the preview in response to a cursor hovering over the thumbnail representation.

7. The method of claim 1 wherein the thumbnail representation is configured for display in a file directory window on the graphical user interface.

8. The method of claim 7 wherein the thumbnail representation is configured for preview by displaying the thumbnail-sized images on the graphical user interface in a preview window separate from the file directory window.

9. The method of claim 8 wherein the thumbnail representation enables the user to simulate the rotation by dragging a cursor within the preview window.

10. The method of claim 8 wherein the thumbnail representation enables the user to simulate the rotation by selecting a rotation arrow displayed within the preview window.

11. The method of claim 1 wherein the thumbnail representation is configured to enable the user to preview the CAD file in an expanded view that is rotatable about multiple axes.

12. The method of claim 1 embodied as a series of processor-executable steps stored in a computer readable medium.

13. A system for generating a rotatable thumbnail representation of a three-dimensional (3D) model of an object stored in a computer-aided design (CAD) file, comprising:
at least one processor;
a computer readable medium that is operatively coupled to the processor; and
logic that executes at least in part in the processor from the computer readable medium and that, when executed, causes generation of the rotatable thumbnail representation by at least:
translating contents of the CAD file into a neutral graphics format;
converting the translated file content into a succession of views of the object, each successive view presenting a different perspective of the object as it rotates about a common axis;
converting the successive views to a sequence of thumbnail-sized images;
associating the sequence with a single thumbnail representation of the CAD file; and
configuring the thumbnail representation to enable a user to preview the CAD file on a graphical user interface by displaying the thumbnail-sized images according to the sequence to simulate rotation of the object about the common axis.

14. The system of claim 13 wherein the common axis is a vertical axis.

15. The system of claim 13 wherein each of the successive views is displaced from adjacent views by a common angle.

16. The system of claim 15 wherein the angle is 30 degrees.

17. The system of claim 13 wherein the single thumbnail representation comprises one of the successive views.

18. The system of claim 13 wherein the thumbnail representation is configured to enable the preview in response to a cursor hovering over the thumbnail representation.

19. The system of claim 13 wherein the thumbnail representation is configured for display in a file directory window on the graphical user interface.

20. The system of claim 19 wherein the thumbnail representation is configured for preview by displaying the thumbnail-sized images on the graphical user interface in a preview window separate from the file directory window.

21. The system of claim 20 wherein the thumbnail representation enables the user to simulate the rotation through placement of a cursor within the preview window.

22. The system of claim 13 wherein the thumbnail representation is configured to enable the user to preview the CAD file in an expanded view that is rotatable about multiple axes.
